(19) United States
(12) Patent Application Publication
(10) Pub. No.: US 2010/0075599 A1
(43) Pub. Date: Mar. 25, 2010

(54) Data Transmission and Exchange Using Spin Waves

(76) Inventors: Haiwen Xi, Prior Lake, MN (US); Song Xue, Edina, MN (US); Dexin Wang, Eden Prairie, MN (US); Dimitar V. Dimitrov, Edina, MN (US)

Correspondence Address: INTELLECTUAL PROPERTY GROUP;SEAGATE TECHNOLOGY FILES, FREDRIKSON & BYRON, PA, 200 SOUTH SIXTH ST, SUITE 4000, MINNEAPOLIS, MN, 55402-1425, US

(21) Appl. No.: 12/234,929

(22) Filed: Sep. 22, 2008

(51) Int. Cl. H04B 7/00

(52) U.S. Cl. 455/41.2

(57) ABSTRACT

Devices are proposed for use in nanoscale data transfer and exchange between electronic components. Spin wave generators translate an input signal charge-carrier based signal to spin waves within a ferromagnetic stripe. The spin waves propagate along the ferromagnetic stripe and are detected by spin wave detectors. Further, signal transfer devices such as a splitter, mixer, and switch are disclosed. Embodiments of the invention provide a solution for replacing copper connections, which is a limiting factor in current and future development of high-performance chips.

### BACKGROUND

In today's progress to miniaturize semiconductor electronic devices, copper connections are a major factor in the design of very large-scale integration (VLSI) chips. These interconnects can be costly and can drain a good part of the energy used to power the chips. In some instances, copper interconnects consume more energy than the transistors within the devices themselves. Additionally, copper interconnects use up valuable space within the device architecture.

Recently, researchers have begun to look for ways to replace copper connections on chips. One potential replacement technology that has emerged involves the propagation of spin waves. A spin wave is a collective oscillation of spin orientations in an ordered spin lattice of a ferromagnetic material. Information encoded into the oscillations of the spin wave can be used to accomplish data transfer between devices capable of detecting and producing such encoded waves. However, before spin waves can be used for reliable and efficient data transfer, structures and devices for generating, transmitting, and detecting spin waves must be developed.

### SUMMARY

In one embodiment in accordance with the invention, a system for data transmission using spin waves includes a ferromagnetic stripe, a spin wave generator, and a spin wave detector. The spin wave generator and detector are coupled at first and second locations on the stripe. In some embodiments, the generator includes a spin-momentum transfer (SMT) effect device. In some embodiments, the generator includes a magnetic field spin wave generator. In some embodiments, the detector includes a magnetic field spin wave detector. In some embodiments, the detector includes an SMT device.

In other aspects of the invention, the system for data transmission using spin waves is extended to provide a plurality of devices. In some embodiments, a splitter is provided by including a branched ferromagnetic stripe, with spin wave detectors coupled to the stripe along each branch. In some embodiments, a mixer is provided by including a branched ferromagnetic stripe, with spin wave generators coupled to the stripe along each branch. In some embodiments, a switch is provided by including a stripe having multiple branches, with a plurality of spin wave generators and detectors residing on each branch. In some embodiments of the devices, detectors can include a filter to selectively receive one or more of a plurality of spin waves propagating within the stripe.

In another aspect, the invention includes methods of transmitting data between devices using spin waves. Methods can include the steps of providing a ferromagnetic stripe and a plurality of SMT effect devices dispersed along the length of the ferromagnetic stripe, at least one of the SMT effect device being a generating SMT effect device and at least one SMT effect device being a detecting SMT effect device. A current representative of a signal is injected into the generating SMT effect device, thereby generating a spin wave in the ferromagnetic stripe. And the detecting SMT effect device detects the spin wave to produce an output signal corresponding to the input signal.

This invention provides devices and methods for data transmission using spin waves. Embodiments of the invention provide reliable and efficient means for generating spin waves corresponding to an input signal within a transmission medium. In addition, detectors according to embodiments of the invention, provide improved means of detecting spin waves within a transmission medium. The improved generation and detection means, in combination with the ferromagnetic stripe transmission medium of embodiments of the invention facilitates efficient data transmission without charge transfer through the use of encoded spin waves.

These and various other features and advantages will be apparent from a reading of the following detailed description.

### BRIEF DESCRIPTION OF THE DRAWINGS

The following drawings are illustrative of particular embodiments of the invention and therefore do not limit the scope of the invention. The drawings are not to scale (unless so stated) and are intended for use in conjunction with the explanations in the following detailed description. Embodiments of the invention will hereinafter be described in conjunction with the appended drawings, wherein like numerals denote like elements.

FIGS. 1A-1D show schematic drawings of spin wave data transmission systems according to embodiments of the invention including combinations of spin-momentum transfer and magnetic field generators, and coplanar strip and magnetoresistive effect detectors.

FIGS. 2A and 2B show schematic drawings of spin wave data transmission systems according to embodiments of the invention including a spin-momentum transfer generator and a spin-momentum transfer junction detector.

FIG. 3A and 3B are schematic drawings of a spin wave data transmission splitter device according to embodiments of the invention.

FIG. 4A and 4B are schematic drawings of a spin wave data transmission mixer device according to embodiments of the invention.

FIG. 5A and 5B are schematic drawings of a spin wave data transmission coupler device according to embodiments of the invention.

FIG. 6A and 6B are schematic drawings of a spin wave data transmission router device according to embodiments of the invention.

FIG. 7 is a schematic drawings of a spin wave data transmission system including a plurality of spin wave generators and detectors along a single ferromagnetic stripe according to embodiments of the invention.

### DETAILED DESCRIPTION OF THE PREFERRED EMBODIMENTS

For the purpose of promoting an understanding of the principles of the invention, reference will now be made to the embodiments illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein, are contemplated as would normally occur to one skilled in the art to which the invention relates.

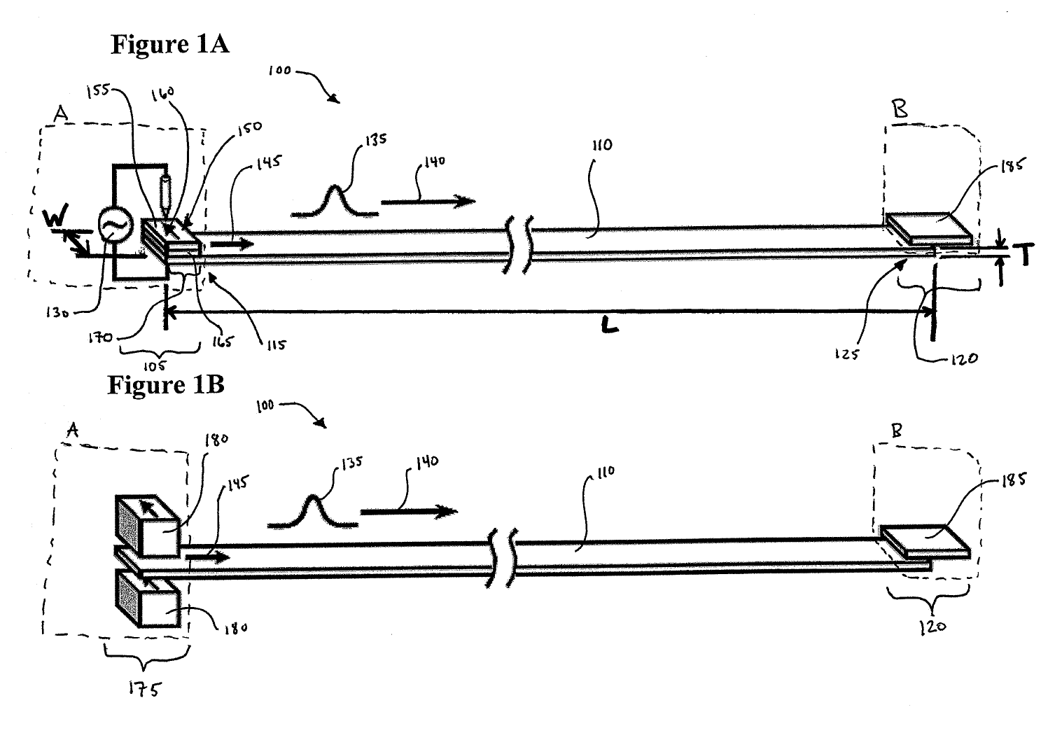

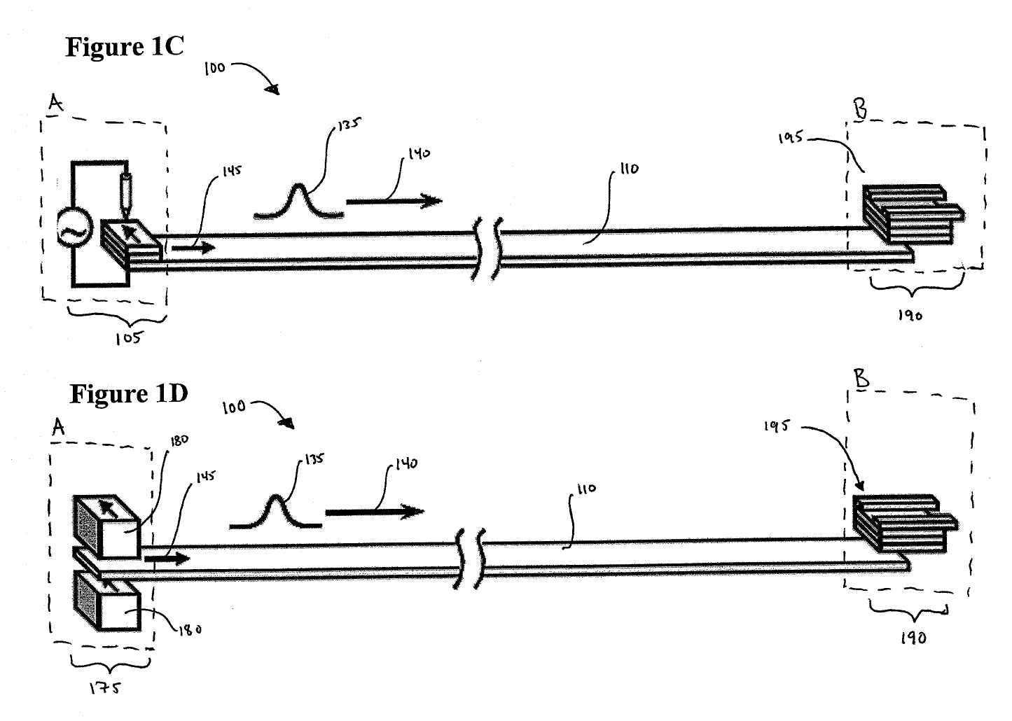

As shown in FIG. 1A, embodiments of the invention include a system for data transmission 100 using spin waves. The system 100 generally includes a spin wave generator 105 coupled to a ferromagnetic (FM) stripe 110 at a first location 115 and a spin wave detector 120 coupled to the FM stripe 110 at a second location 125. An input signal 130 delivered from a transmitting device A can be passed to the spin wave generator 105 which causes a spin wave 135 to be generated within the FM stripe 110. Spin wave propagates by changing the local polarization of spins of nearby ferromagnetic material. Thus, spin waves propagate without the transfer or movement of charge carriers within the spin wave media, i.e. the FM stripe 110. The spin wave 135, having propagated through the FM stripe 110 (e.g. in the direction of arrow 140), can then be detected by the spin wave detector 120 and translated into an output signal which corresponds to the input signal 130. The output signal can thus be received by a receiving device B coupled with the detector 120. In this manner, systems according to the invention can accomplish data transfer between devices A, B located at or near the first and second locations 115,125 with spin waves (rather than charge transfer) serving as the data carrier between the devices.

The FM stripe 110 is a patterned film of a ferromagnetic material deposited on or within a substrate between devices to be connected. The stripe has thickness T, width W and length L dimensions. The stripe length L is the dimension of the stripe between the devices A, B to be connected. In some embodiments, the FM stripe 110 comprises a single layer of FM material. However, the stripe should not be limited to such, for example in some embodiments, the stripe can comprise a multi-layer structure. A multi-layer FM stripe can comprise for example two or more exchange-biased layers, such as for example a ferromagnetic layer and an antiferromagnetic layer. Multilayer coupling can be used to pin the magnetization direction or adjust sensitivity of the FM stripe to provide for improved transmission of spin waves. The magnetization direction of the FM stripe is indicated by arrow 145. In the embodiment of FIG. 1A, the direction of magnetization 145 is generally parallel with the stripe length L, however the magnetization direction 145 can be oriented in generally any direction. For example, the direction of magnetization can be perpendicular with the stripe length L (i.e. along the stripe width W), out of the stripe plane (i.e. along the stripe thickness T), or at any combination of angles relative to the various axes of the stripe.

The FM stripe 110 can comprise generally any ferromagnetic material. For example, the FM stripe can comprise ferromagnetic transition metals and their alloys. In some embodiments, the FM stripe 110 comprises a ferromagnetic film, such as for example, Ni, Co, Fe and their alloys, and doped materials including for example, CoFeB. A multi-layer FM stripe can comprise a ferromagnetic film deposited upon an antiferromagnetic film, for example IrMn (CoO). The materials and structure selected for the FM stripe can effect the characteristics and ability to generate spin waves therein. For example, a “softer” FM material can allow for generation of spin waves of greater magnitude, yet with higher attenuation. In addition, the frequencies of the excited spin waves depend upon the magnetic properties of the FM stripe. Width W and thickness T dimensions of the stripe 110 can be on the submicron scale. For example, embodiments can include an FM stripe approximately 500 nm thick and less than 500 nm wide. The stripe length L can be up to 2 cm depending upon the level of attenuation of spin waves within the stripe. Spin wave attenuation within the FM stripe 110 depends on stripe material properties including, for example, crystal geometry, imperfections, impurities, and anisotropy bias. External factors such as external magnetic field and temperature can likewise affect spin wave attenuation within the stripe and further limit the stripe length L. In any case, the FM stripe should be provided such that spin waves generated therein have a propagation vector along the length of the stripe.

The FM stripe, as well as all components described below including generators and detectors, can be fabricated by any techniques known in the art. For example, known lithographic and deposition techniques or other standard thin film processes can be used to provide the components described herein.

The generator 105 is one of the basic system components according to embodiments of the invention. In some embodiments, such as that of FIG. 1A, the generator 105 can be a spin-momentum transfer (SMT) device (also referred to as a “spin torque transfer” (STT) device). In such devices, spin waves 135 are locally generated within the FM stripe 110 by the injection of a current through a stack 150. In SMT excitation approaches, the frequency of the locally generated spin waves can be selected and tuned by the injected current density. By controlling the magnitude and frequency of the injected current (or applied voltage), i.e. where the injected current is representative of a signal 130, the generated spin wave 135 can be encoded with the signal 130.

SMT devices in most embodiments, comprise a stack of layers 150. The stack 150 generally includes at least three layers: (i) a pinned FM layer 155 having a generally fixed magnetization direction 160, (ii) a non-magnetic spacer layer 165, and (iii) a free layer. When SMT devices are used as spin wave generators according to embodiments the invention, the pinned layer 155 and nonmagnetic spacer 165 are deposited directly adjacent to a segment of the FM stripe 170, which corresponds to the free layer. Thus, the generator 105 is integral with the stripe 1 10. Current injected through the stack 150 passes through the pinned layer 155 which functions as a spin polarizer to polarize the spins of the electrons of the current with the spins of electrons residing in the pinned layer 155. Current then flows through the nonmagnetic spacer 165 and into the stripe segment 170, where the polarized spins of the current exert a torque on the spins of the pinned layer electrons. In embodiments wherein the spacer 165 comprises an insulating nonmagnetic material (e.g. a thin oxide layer), the device is referred to as a magnetic tunnel junction (MTJ). Where the nonmagnetic spacer comprises a conducting layer (e.g. a nonmagnetic metallic layer), the device is referred to as a spin valve. Generators 105 according to embodiments of the invention can be of either arrangement. With respect to the stripe segment 170, one should note that it is not a free layer in which the magnetization direction is switched by the injected current. Rather, the magnetization direction of the FM stripe 145 remains generally fixed with the SMT effect of the injected current causing the generation of spin waves 135.

Spin wave generation by SMT stacks can occur so long as the magnetization direction of the stripe 145 (“first magnetization direction”) is not oriented in the same direction as the magnetization direction of the pinned layer 160 (“second magnetization direction”). Thus, generators 105 according to some embodiments of the invention include a second magnetization direction 160 that is different from the first magnetization direction 145. In some embodiments, the second magnetization direction 160 is perpendicular to the first magnetization direction 145 so as to maximize the torque exerted upon the magnetic moments of electrons in the FM stripe and provide spin waves 130 of maximum magnitude.

It should be recognized that the above described SMT stack represents a simple variation of such a device. Many other stacks comprising more layers of different composition, thickness, and arrangement can provide the SMT effect and all such variations should be considered to be within the scope of the invention. Moreover, the various SMT stacks can be substituted (where appropriate) for any SMT stack used in systems and devices of the invention, be it as a generator, stripe, detector, or other system component.

Another type of generator 175 is shown in FIG. 1B. Here, spin wave generation is accomplished using a magnetic field source 175, such as magnets 180, magnetically or directly coupled to the stripe 110. Magnetic field spin wave generation can be described as a more indirect method of spin wave generation than SMT effect spin wave generation, because the input signal or a current corresponding thereto must first be translated to a varying magnetic field, which then interacts with the FM stripe to generate the spin wave. The translation of an electrical signal into a varying magnetic field can be accomplished by a copper lead, as any such lead will induce a magnetic field about the lead when a current is passed therethrough. Certain embodiments of the invention include an enhanced magnetic field generator which can generate a magnetic field having a greater magnitude than that of a lead or plurality of co-planar leads. A write head is one example of an enhanced magnetic field generator. In such devices, a current representing the signal can be passed through a coil about a magnetic write tip. The energized coil induces a magnetic field in a gap of the write tip. This magnetic field can then be used to stimulate and tune spin wave formation within the FM stripe 110.

Systems according to embodiments of the invention further include detectors 120 magnetically or physically coupled to the FM stripe 110 to detect a propagated spin wave 135 therein and provide a corresponding output signal. As can be seen in FIGS. 1A and 1B, a detector 120 is provided on the FM stripe 110 at a second location 125 along the stripe length L and positioned relative to the stripe such that the detector 120 can perceive the spin wave 135.

Detectors can be positioned to directly or indirectly perceive the spin wave. For example, the detectors of FIGS. 1A and 1B represent one form of indirect detectors. Here, the detector is one or more coplanar waveguide strips or metallic leads 185 within which a current is induced by the proximity to the propagating spin wave 135.

FIGS. 1C and 1D show schematics of systems including an enhanced magnetic field detector 190. In these examples, the detector 190 is a magnetic read head 195. A read head utilizes the magnetoresistive effect to provide an output signal having a large amplitude relative to small changes in magnetic field. Many such devices comprise a stack of at least three layers: (i) a pinned layer, (ii) a nonmagnetic spacer layer, and (iii) a free layer. The pinned layer is a magnetic layer having a generally fixed magnetization direction. The spacer layer is generally nonmagnetic and can comprise a conductive material (e.g. a metal), or an insulating material (e.g. a thin oxide layer). The free layer comprises a soft magnetic material having a free or unfixed direction of magnetization. In the presence of an external magnetic field (such as that provided by the propagating spin wave), the spins of electrons of the free layer change orientation, which causes the resistance of the entire stack to vary. For example, when the spins of the electrons in the free layer are oriented parallel with the spins of electrons of the pinned layer the stack provides the least resistance. As the spins of the free layer are pulled toward antiparallel relative to the pinned layer, the stack resistance increases. Thus, a read current or voltage applied to the read head can pick up the changing resistance of the head and provide an output signal corresponding to the spin wave causing the changes in the free layer.

One of skill in the art will recognize that the detector signal-to-field ratio can be improved by using a detector having a high magnetoresistance ratio. For this reason, some embodiments use a magnetic tunnel junction arrangement where the spacer layer comprises a thin oxide or other insulating layer. However, detectors should not be limited to such, for example, a spin valve (having a conductive spacer layer) can be used. Moreover, the stack need not be limited to the three layers described above. Many read head or other enhanced magnetic field sensors can be used and all such devices should be considered as within the scope of the invention.

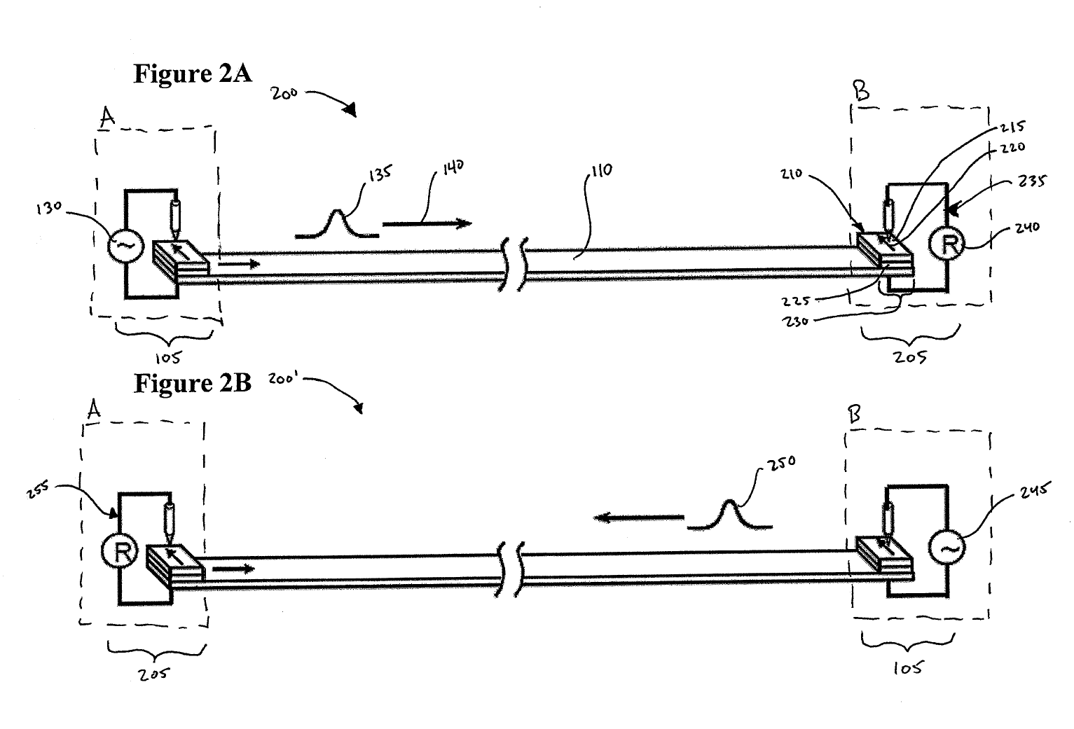

FIG. 2A shows an example of a system 200 including a local magnetoresistive effect (LMRE) detector 205 coupled to the receiving device B. In this embodiment, the detector 205 is generally structurally analogous to the SMT generator 105 of FIGS. 1A and 1B. That is, the detector 205 comprises a stack of layers 210 directly coupled with the FM stripe 110. For example, the stack 210 can comprise at least three layers: (i) a pinned FM layer 215 having a fixed magnetization direction 220, (ii) a nonmagnetic spacer layer 225, and (iii) a segment of the FM stripe 230. With contrast to the enhanced magnetic field detectors 190 of FIGS. 1C and 1D, where output signal is produced relative to a magnetic field, the resistance of a LMRE detector 205 is locally generated by the propagating spin wave 135. This is due to the incorporation of a segment of the FM stripe 230 in the stack 210. Like the read head above, parallel orientation of the spins of the electrons in the stripe segment 230 and the pinned layer 215 yield a relatively low resistance. As the relative spin orientations of these layers moves toward antiparallel, the resistance of the stack 210 increases. Thus, embodiments including a LMRE detector have a pinned layer magnetization direction 220 that is not parallel with the magnetization direction of the FM stripe 145, for example, the magnetization directions can be arranged at a 90 degree angle relative to each other. LMRE detectors 205 further include read-out circuitry 235 for applying a read current or voltage 240 to the stack 210. Fluctuations in the LMRE detector 205 resistance caused by the propagating spin wave can thus be detected as changes in the read current or voltage 240.

An additional benefit of providing a LMRE detector 205 can be seen in the system 200′ of FIG. 2B. Here, without changing the system layout of FIG. 2A, where device A was transmitting a signal 130 to device B, a signal 245 is being transmitted from device B to device A. In other words, the generator 105 coupled with device A in FIG. 2A is used as a detector 205 for device A in FIG. 2B. Meanwhile, the detector 205 coupled with device B in FIG. 2A, is used as a generator 105 to generate a spin wave 250 representative of the signal 245 provided by device B in FIG. 2B. Thus, by providing an SMT stack according to embodiments of the invention with a switchable connection to input signal 130, 245 and readout circuitry 235, 255, the stack can provide both spin wave generation and detection functionality to a connected device. This allows for devices to be simplified because instead of having to provide both generator and detector structures to accomplish two-way data transfer, only one structure need be provided. For purposes of this application, the terms “SMT device” and “SMT effect device” shall generally refer to a stack of layers such as those described herein, irrespective of their function. For example, the term “SMT device” should be interpreted to include and describe both SMT generators and LMRE stacks. Some magnetic field devices can likewise be used as both generators and detectors. For example, metallic coplanar waveguide strips, can be arranged about the FM stripe such that the strips can both generate a magnetic field (for creating spin waves) and sense a magnetic field (for detecting spin waves and producing an output signal).

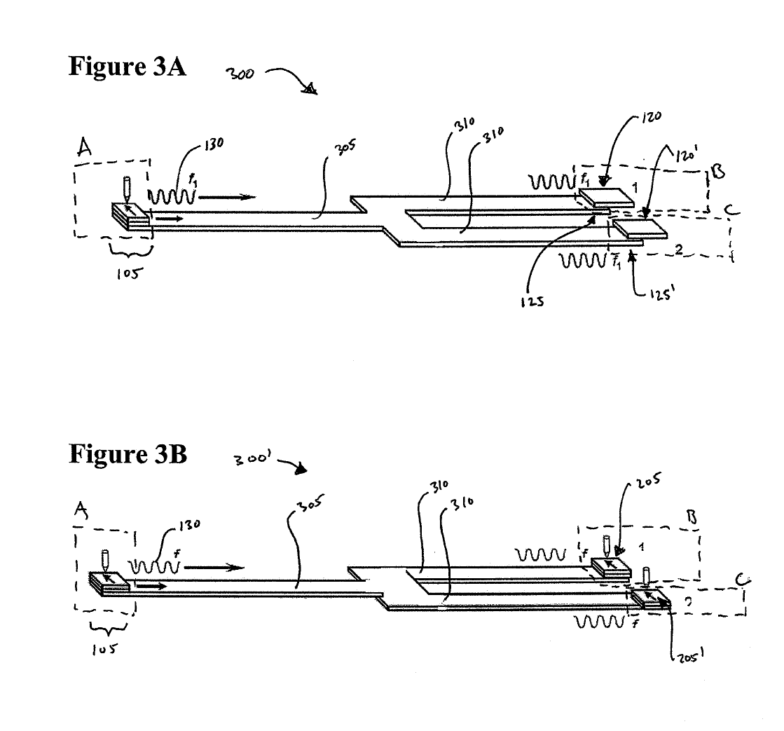

With the basic structure having been illustrated, many devices can be built for particular functions. FIG. 3A shows a device 300 with an FM stripe 305 having branches 310 to function as a splitter 300. Each branch 310 of the stripe 305 includes a detector 120, 120′ positioned thereon. In such embodiments, the data carrying spin waves 130 generated by the generator 105 at a single first location 110 propagate through the branched stripe and reach two separate second locations 125, 125′ along the stripe 305. Thus, a single device A coupled with the generator 105 can simultaneously communicate with multiple receiving devices B, C coupled with each detector 120, 120′. As can be seen in FIG. 3B, the detectors need not be magnetic field detectors, as shown in FIG. 3A, but can be replaced with LMRE detectors 205, 205′ to accomplish the same splitter function.

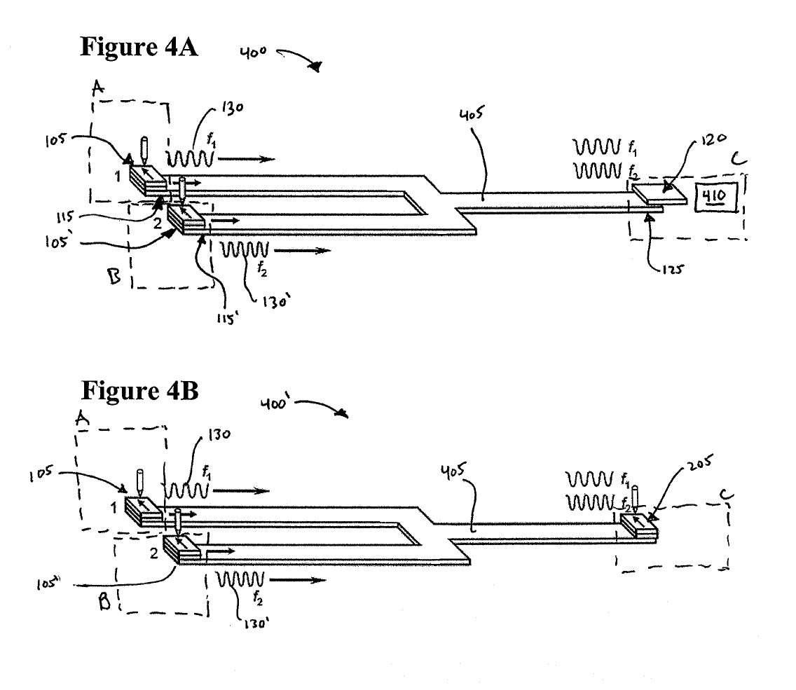

Similarly, a signal mixer 400 with a branched FM stripe 405 and at least two spin wave generators 105, 105′ can be constructed as shown in FIG. 4A. Data in the form of spin waves 130, 130′ generated at the generator locations 115, 115′ can propagate along the branched stripe 405 to be received by a common detector 120 at a single second location 125. Thus, multiple devices A, B can simultaneously communicate with a single receiving device C. For example the data transmitted from devices A, B at each generator 105, 105′ can provide spin waves 130, 130′ at different frequencies f₁,f₂. A filter 410 can be included at the receiving device C or the common detector 120 to select a signal having a particular frequency to differentiate between the two sources 105, 105′. The filter 410 can comprise a hardware component coupled with the detector 120 or installed within device C. Alternatively, the filter can be a software process implemented within or by a component separate from device C. FIG. 4B shows the mixer 400 of FIG. 4A wherein the field detector 120 has been replaced with an LMRE detector 205. One can appreciate that, given the two-way communication capabilities of the LMRE detector and generators (as discussed above), the mixer 400′ of FIG. 4B is analogous to the splitter 300′ of FIG. 3B. To switch from mixer to splitter, the read-out circuit coupled with the detector 120 can be switched out for a signal input circuit. Likewise, the signal input circuits of one or more of the generators 105, 105′ can be switched out for a read-out circuit. Thus, the branched FM stripe 405 can transmit a signal generated at the LMRE detector 205 to be received by the SMT generators 105, 105′. Note that if one or more of the generators are not capable of two-way communication, the system of FIG. 4B is not operational as a splitter with respect to that generator.

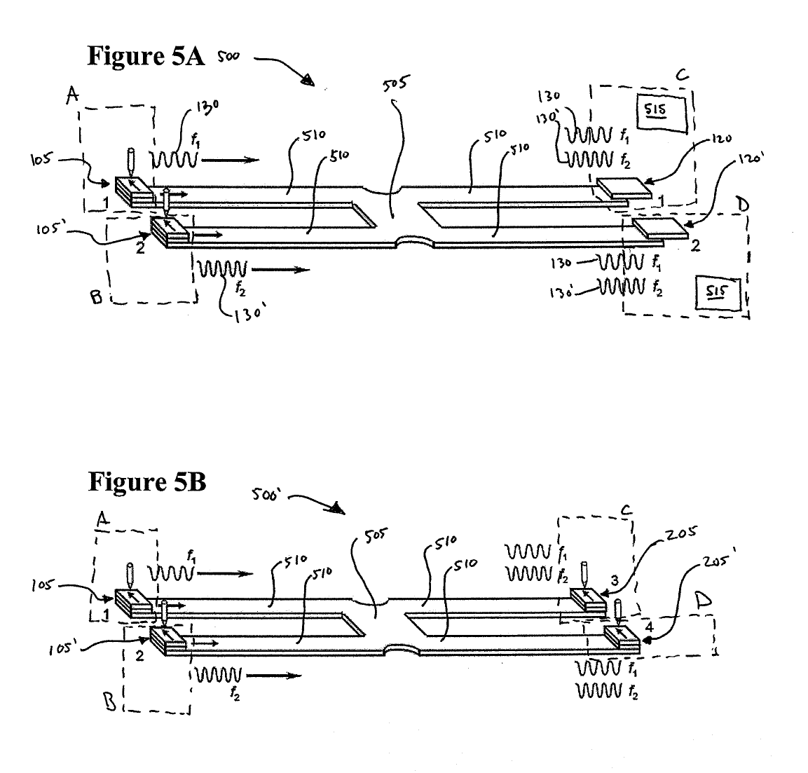

FIG. 5A shows a coupler 500 according to embodiments of the invention. The coupler 500 comprises a branched FM stripe 505 having branches 510 for spin wave generators 105, 105′ coupled with input devices A, B and branches 510 for spin wave detectors 120, 120′ coupled with output devices C, D. Such a coupler 500 can also be created by providing two separate FM stripes connected at a location. When carried by spin wave packets 130, 130′ of different frequencies e.g. frequencies f₁ and f₂, the detectors 120, 120′ or their associated devices C, D can include filters 515 to selectively receive one or more of the transmitted signals. Likewise, FIG. 5B shows a system including a branched FM stripe 505 so as to provide a coupler 500′. Here, it should be noted that detectors 205, 205′ are LMRE detectors, allowing for two-way communication. Thus, in a system where each generator is also capable of two-way communication, each of the SMT stacks 105, 105′, 205, 205′ of FIG. 5B, can send and receive signals to and from each of the other stacks.

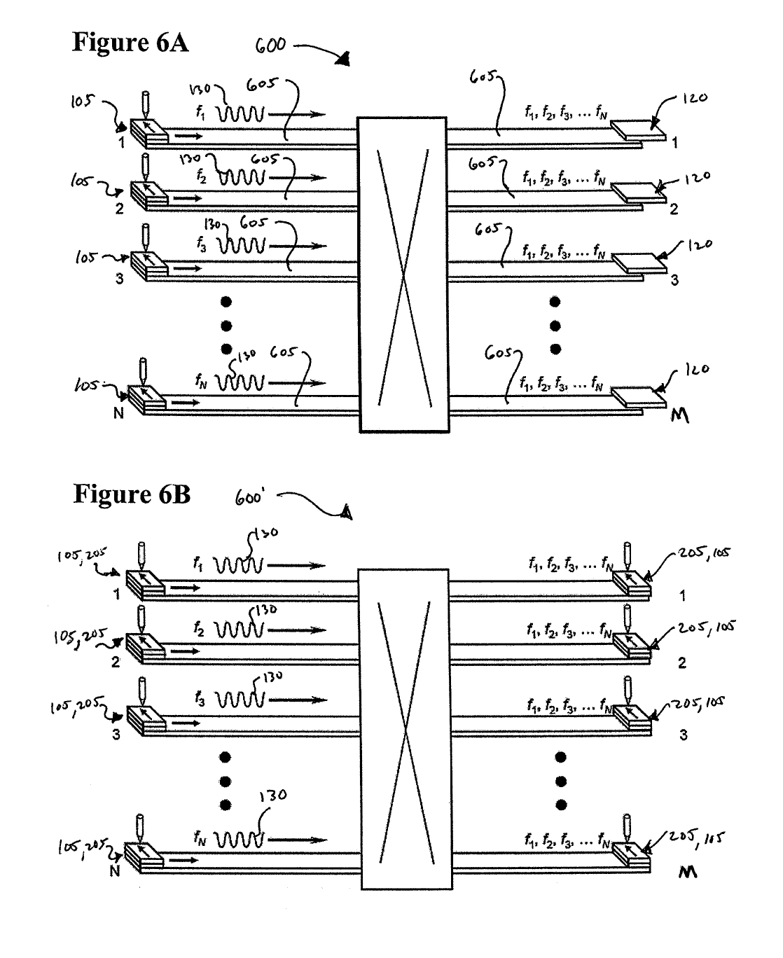

The proposed coupler can be extended to a router 600, or exchanger, with N-branches of an FM stripe 605 coupled with spin wave generators 105 and M-branches of an FM stripe 605 coupled with spin wave detectors 120 as seen in FIG. 6A. As above, a filter can be connected with each of the detectors 120 or their associated devices for frequency or other signal selection functionality. Likewise, FIG. 6B shows a router 600′ arrangement where each generator 105 and detector 205 comprise an SMT stack, thus each stack coupled with the router can send or receive signals in the form of spin waves 130. In the embodiment shown in this figure, the generators and detectors have become indistinguishable because each stack is capable of both generation and detection (as discussed above).

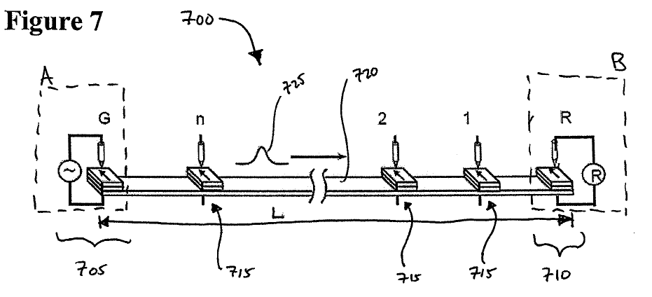

FIG. 7 shows a schematic of a system 700, wherein a spin wave generator 705, detector 710, and a plurality of intermediate SMT stacks 715 have been positioned along a single FM stripe 720. Such an arrangement can be useful, for example, for delivering a spin wave 725 signal between distant (i.e. where stripe length L is such that spin wave attenuation becomes a concern) devices A, B. Each intermediate SMT stack 715 can be used as a repeater to provide for amplification of the spin wave as it propagates through the FM stripe 720. Amplification can be accomplished, for example, by successive detection and retransmission. For example, in this embodiment, each successive intermediate SMT stack 715 can detect the spin wave 725 and regenerate a duplicate spin wave to decrease the effects of spin wave attenuation along the length L of the FM stripe 720. Alternatively, each intermediate SMT stack 715 can be coupled with a separate device so that each device receives the signal transmitted by the generator 705. In such an arrangement, each intermediate SMT stack 715 can be used to generate a spin wave to be received by all other devices along the FM stripe 720. One should recognize that the intermediate detectors/generators need not be SMT stacks as shown, but rather could be any combination of any of the types of detectors and/or generators described above.

Thus, embodiments of devices and systems for data transmission using spin waves are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention and the scope of the appended claims.

What is claimed is:

1. A system for data transmission using spin waves comprising:
a ferromagnetic (FM) stripe having a first magnetization direction and a stripe length;
a spin wave generator coupled to the FM stripe at a first location along the stripe length, the spin wave generator configured to convert an input signal to a spin wave which propagates along the stripe length; and
a spin wave detector coupled to the FM stripe at a second location along the stripe length such that the detector can detect the propagated spin wave and produce a corresponding output signal.

2. The system of claim 1, wherein the first magnetization direction is oriented generally parallel with the stripe length.

3. The system of claim 1, wherein the first magnetization direction is oriented generally perpendicular with the stripe length.

4. The system of claim 1, wherein the FM stripe is a multi-layer structure.

5. The system of claim 1, wherein the spin wave generator is a spin-momentum transfer (SMT) effect device including a stack of layers, the layers comprising:
a pinned layer, having a second magnetization direction that is different than the first magnetization direction;
a segment of the FM stripe; and
a nonmagnetic spacer layer between the segment of the FM stripe and the pinned layer.

6. The system of claim 5, wherein the SMT effect device comprises a magnetic tunnel junction.

7. The system of claim 5, wherein the SMT effect device comprises a spin-valve.

8. The system of claim 5, wherein the second magnetization direction is oriented generally perpendicular to the first magnetization direction.

9. The system of claim 1, wherein the spin wave detector is a local magnetoresistive effect (LMRE) device including a stack of layers, the layers comprising:
a pinned layer, having a third magnetization direction that is different than the first magnetization direction;
a segment of the FM stripe; and
a nonmagnetic spacer layer between the segment of the FM stripe and the pinned layer.

10. The system of claim 9, wherein the LMRE device comprises a magnetic tunnel junction.

11. The system of claim 9, wherein the LMRE device comprises a spin-valve.

12. The system of claim 9, wherein the third magnetization direction is oriented generally perpendicular to the first magnetization direction.

13. The system of claim 1, wherein the spin wave generator comprises an enhanced magnetic field generator.

14. The system of claim 13, wherein the enhanced magnetic field generator comprises a write head including a current coil wrapped around a magnetic core.

15. The system of claim 1, wherein the spin wave detector comprises a magnetic field sensor.

16. The system of claim 15, wherein the magnetic field sensor comprises a coplanar strip.

17. The system of claim 15, wherein the magnetic field sensor comprises a magnetoresistive effect device.

18. The system of claim 1, comprising a plurality of detectors, each residing on a branch of the FM stripe, the system thus acting as a splitter.

19. The system of claim 1, comprising a plurality of generators, each residing on a branch of the FM stripe, the system thus acting as a mixer.

20. The system of claim 1, comprising a plurality of generators and a plurality of detectors, each residing on a branch of the FM stripe, the system thus acting as a switch.

21. The system of claim 20, wherein the switch comprises a signal exchanger dispersed between the branches of the FM stripe.

22. The system of claim 1, further comprising a filter coupled with the detector for selecting a component signal of the spin wave, the output signal corresponding to the selected component signal.

23. A system for interconnecting electronic components using spin waves as data carriers comprising:
a ferromagnetic (FM) stripe having a first magnetization direction and a stripe length;
a plurality of spin-momentum transfer (SMT) effect devices dispersed along the stripe length, each SMT effect device being coupled with one or more of the electronic components being connected, wherein at least one SMT effect device is a generating SMT effect device configured to generate spin waves within the magnetic stripe and at least one SMT effect device is a detecting SMT effect device configured to detect spin waves in the magnetic stripe, each SMT effect device including a stack of layers, the layers comprising:
a pinned layer, having a junction magnetization direction that is different than the first magnetization direction;
a portion of the FM stripe; and
a nonmagnetic spacer layer between the portion of the FM stripe and the pinned layer.

24. The system of claim 23, wherein the SMT effect devices comprise magnetic tunnel junctions.

25. The system of claim 23, wherein the junction magnetization direction of each SMT effect device is oriented generally perpendicular to the first magnetization direction.

26. The system of claim 23, wherein one or more of any SMT effect device positioned between the generating SMT effect device and detecting SMT effect device is a repeater.

27. A method of transmitting data between devices comprising the steps of:
providing a ferromagnetic (FM) stripe having a first magnetization direction oriented along a length of the FM stripe; a plurality of spin-momentum transfer (SMT) effect devices dispersed along the length of the FM stripe, wherein at least one SMT effect device is a generating SMT effect device and is configured to generate spin waves in the FM stripe and at least one SMT effect device is a detecting SMT effect device and is configured to detect spin waves in the magnetic stripe, each SMT effect device including a stack of layers, the layers comprising: a pinned layer, having a magnetization direction fixed substantially perpendicular to the first magnetization direction of the stripe; a portion of the FM stripe; and a nonmagnetic spacer layer residing between the FM stripe and the pinned layer;
injecting a current representative of a signal into the pinned layer of the at least one generating SMT effect device, thereby generating a spin wave in the FM stripe, the spin wave representative of the signal;
detecting the spin wave, and thereby the signal, at the at least one detecting SMT effect device.

28. The method of claim 27, wherein the current injected into the at least one generating SMT effect device is a pulsed current.

29. The method of claim 27, further comprising the steps of:
providing at least intermediate SMT effect device along the FM stripe, between the generating SMT effect device and the detecting SMT effect device;
repeating the spin wave in the FM stripe by detecting the spin wave with the intermediate SMT effect device and generating a duplicate spin wave with the intermediate SMT effect device, the duplicate spin wave being substantially similar to the original spin wave; and
detecting the duplicate spin wave at the detecting SMT effect device.
